(19) United States
(12) Patent Application Publication
(10) Pub. No.: US 2026/0034444 A1
(43) Pub. Date: Feb. 5, 2026

(54) METHOD AND APPARATUS FOR CONTROLLING VIRTUAL OBJECT, COMPUTER DEVICE, AND STORAGE MEDIUM

(71) Applicant: Tencent Technology (Shenzhen) Company Limited, Shenzhen (CN)

(72) Inventor: Liang ZHANG, Shenzhen (CN)

(73) Assignee: Tencent Technology (Shenzhen) Company Limited, Shenzhen (CN)

(21) Appl. No.: 19/355,289

(22) Filed: Oct. 10, 2025

Related U.S. Application Data
(63) Continuation of application No. PCT/CN2024/136628, filed on Dec. 4, 2024.

(30) Foreign Application Priority Data
Jan. 17, 2024 (CN) 202410069424.7

(51) Int. Cl. A63F 13/52; A63F 13/58

(52) U.S. Cl. CPC A63F 13/52; A63F 13/58

(57) ABSTRACT

A method, apparatus, and computer-readable storage medium for controlling virtual objects with dynamic skill acquisition mechanics. The method displays a first virtual object with a first identity type and corresponding first skill, and a second virtual object with a second identity type and corresponding second skill in a virtual scene. When the first virtual object defeats the second virtual object, a virtual resource is displayed as dropped from the defeated object. Through an interaction operation with this dropped virtual resource, the first virtual object obtains the second skill originally possessed by the second virtual object, enabling cross-identity skill acquisition through combat victory and resource interaction.

### CROSS-REFERENCE TO RELATED APPLICATIONS

This application is a continuation application of International Application No. PCT/CN2024/136628 filed on Dec. 4, 2024 which claims priority to Chinese Patent Application No. 202410069424.7, filed with the China National Intellectual Property Administration on Jan. 17, 2024, the disclosures of each being incorporated by reference herein in their entireties.

### FIELD

The disclosure relate to the field of computer technologies, a method and apparatus for controlling a virtual object, a computer device, and a storage medium.

### BACKGROUND

In an electronic game, a player may control a virtual object to attack other virtual objects to defeat the other virtual objects. Virtual objects of different types possess different skills, and a virtual object of each type only uses a respective skill to battle. Therefore, there is a great limitation, leading to poor player experience.

### SUMMARY

Provided are a method and apparatus for controlling a virtual object, a device, a storage medium, and a program product, which can implement dynamic skill acquisition through virtual combat and resource interaction mechanics.

According to some embodiments, a method for controlling a virtual object, performed by a computer device, includes: displaying, in a virtual scene, a first virtual object of a first identity type possessing a first skill of the first identity type; displaying, in a virtual scene, a second virtual object of a second identity type possessing a second skill of the second identity type; displaying a virtual resource dropped from the second virtual object in a case that the first virtual object defeats the second virtual object; and displaying that the first virtual object obtains the second skill based on an interaction operation of the first virtual object for the virtual resource dropped from the second virtual object.

According to some embodiments, an apparatus for controlling a virtual object, includes: at least one memory configured to store program code; and at least one processor configured to read the program code and operate as instructed by the program code, the program code including: first display code configured to cause at least one of the at least one processor to display, in a virtual scene, a first virtual object of a first identity type possessing a first skill of the first identity type; second display code configured to cause at least one of the at least one processor to display, in a virtual scene, a second virtual object of a second identity type possessing a second skill of the second identity type; resource code configured to cause at least one of the at least one processor to display a virtual resource dropped from the second virtual object in a case that the first virtual object defeats the second virtual object; and skill code configured to cause at least one of the at least one processor to display that the first virtual object obtains the second skill based on an interaction operation of the first virtual object for the virtual resource dropped from the second virtual object.

According to some embodiments, a non-transitory computer-readable storage medium, storing computer code which, when executed by at least one processor, causes the at least one processor to at least: display, in a virtual scene, a first virtual object of a first identity type possessing a first skill of the first identity type; display, in a virtual scene, a second virtual object of a second identity type possessing a second skill of the second identity type; display a virtual resource dropped from the second virtual object in a case that the first virtual object defeats the second virtual object; and display that the first virtual object obtains the second skill based on an interaction operation of the first virtual object for the virtual resource dropped from the second virtual object.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of battle matching provided by some embodiments.

FIG. 2 is a schematic diagram of a game mode provided by some embodiments.

FIG. 3 is a schematic diagram of a virtual scene map provided by some embodiments.

FIG. 4 is a schematic diagram of an implementation environment of a method for controlling a virtual object provided by some embodiments.

FIG. 5 is a flowchart of a method for controlling a virtual object provided by some embodiments.

FIG. 6 is a flowchart of another method for controlling a virtual object provided by some embodiments.

FIG. 7 is a schematic diagram of a virtual scene interface provided by some embodiments.

FIG. 8 is a schematic diagram of a skill obtaining mode provided by some embodiments.

FIG. 9 is a schematic diagram of a skill adapting method provided by some embodiments.

FIG. 10 is a flowchart of another method for controlling a virtual object provided by some embodiments.

FIG. 11 is a schematic diagram of another virtual scene interface provided by some embodiments.

FIG. 12 is a flowchart of another method for controlling a virtual object provided by some embodiments.

FIG. 13 is a schematic structural diagram of an apparatus for controlling a virtual object provided by some embodiments.

FIG. 14 is a schematic structural diagram of another apparatus for controlling a virtual object provided by some embodiments.

FIG. 15 is a schematic structural diagram of a terminal provided by some embodiments. embodiments.

FIG. 16 is a schematic structural diagram of a server provided by some

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms “first”, “second”, and the like used in this application may be used for describing herein various concepts which, however, are not limited by these terms unless otherwise specified. The terms are merely used for distinguishing one concept from another concept. By way of example, without departing from the scope of this application, a first virtual object may be referred to as a second virtual object, and similarly, a second virtual object may be referred to as a first virtual object.

Information (including, but not limited to, user equipment information, user personal information, and the like), data (including, but not limited to, data for analysis, data for storage, data for showing, and the like), and signals (including, but not limited to, signals for transmission between a user terminal and other devices) involved in this application are all authorized by users or fully authorized by all parties. Collection, use, and processing of relevant data may comply with relevant laws, regulations, and standards of relevant countries and regions.

For ease of understanding, nouns involved in some embodiments are explained below.

Virtual scene: This noun refers to a virtual scene displayed (or provided) when an application program runs on a terminal. The virtual scene may be a simulated environment of the real world, may be a semi-simulated and semi-fictional environment, or may be a purely fictional virtual environment. The virtual scene may be any one of a two-dimensional virtual scene, a 2.5-dimensional virtual scene, or a three-dimensional virtual scene. The dimensions of the virtual scene are not limited in the embodiments of the present disclosure. For example, the virtual scene may include sky, land, sea, or the like. The land may include environmental elements such as desert and city. A user can control the virtual object to move in the virtual scene. In one embodiment, the virtual scene may be further configured for a virtual scene battle between at least two virtual objects, and there are virtual items available for use by the at least two virtual objects in the virtual scene. For example, the virtual items include virtual props in a fight, virtual potions for healing, virtual props for leveling up, virtual gold coins for trading, and the like.

Virtual object: This noun refers to a movable object in the virtual scene. The movable object may be a virtual person, a virtual animal, a virtual elf, a cartoon character, or the like. The virtual object may be a virtual image representing a user in the virtual scene. The virtual scene may include a plurality of virtual objects therein, and each virtual object has a shape and a volume in the virtual scene, and occupies some space in the virtual scene. In one embodiment, when the virtual scene is a three-dimensional virtual scene, the virtual object may be a three-dimensional model, and the three-dimensional model may be a three-dimensional character built based on a three-dimensional human skeleton technology. The same virtual object may show different external appearances by wearing different skins. In some embodiments, the virtual object may alternatively be implemented by using a 2.5-dimensional model or 2-dimensional model. This is not limited in some embodiments.

In one embodiment, the virtual object may be a player character controlled through operations on a client, artificial intelligence (AI) set in a fight in the virtual scene by training, or a non-player character (NPC) set in interactions in the virtual scene. In one embodiment, the virtual object may be a virtual person for battling in the virtual scene. In one embodiment, a number of virtual objects participating in interactions in the virtual scene may be preset, or may be dynamically determined based on a number of clients participating in the interactions.

Skill: This noun refers to an interactive skill that can be cast by a virtual object in a virtual scene. Usually, virtual objects of different identity types are bound to different exclusive skills, and a user may select which exclusive skills to be used in the current battle, and there is an upper limit on a number of exclusive skills that can be used in the battle. Skill types of skills may include an attack skill, a defense skill, a healing skill, a support skill, an execution skill, and the like. Usually, after a virtual object casts a skill, the skill has a skill cool down (CD). A user cannot cast the skill again during the skill CD. The skill may restore to a castable state only after the skill CD ends. Different skills may have the same or different lengths of skill CD, and not all skills have the skill CD. A skill without the skill CD may be considered as the skill CD being 0.

MMORPG game: This noun refers to a massive multiplayer online role-playing game, which is a multiplayer game played on the Internet, and may be designed to simulate a virtual world such as an ancient world or a modern magic world. A player may select a virtual object to go through a specified adventure task in the virtual world. The player may control the virtual object to freely roam in the virtual world. In addition, the player may further play a role by selecting virtual objects of different identity types, or may explore a new place in the virtual world, solve a puzzle, establish a new group, or participate in a story. Moreover, by means of battle matching, a plurality of players may participate in the same game battle in the virtual world, and in the game battle, different players may manipulate virtual objects to attack one another, contend for virtual items in the virtual world, and so on.

In one embodiment, a non-zero-sum game extraction play mode is provided in the MMORPG game. The game extraction play mode belongs to a Takov game. Random matching is performed among players. A matched virtual object selected by each player is spawned on a map. A battle target is to control the virtual objects to extract them out of the map. If the virtual object is defeated by another virtual object, a virtual item obtained on the map is dropped. The non-zero-sum refers to that a plurality of players in a game battle may achieve a win-win, and a player does not certainly fail when the player wins another player. For example, more than one of the players participating in the game battle can successfully extract out of the map, and instead, a plurality of players all successfully extract out of the map, thereby achieving a win-win.

The following describes the MMORPG game in detail.

In the MMORPG game, a player may participate in a battle as an individual, or may participate in a battle in a team. When the player participates in a battle in a team, each team has three virtual objects at most, and each virtual object has a respective identity type. The identity types of the virtual object in the same team may be repeated. Exemplarily, an identity type of a virtual object may be:

Warrior: It features high health points, high defense power, high attack power, short attack range, and flexible movement, and can resist damage from an opponent to some extent or cause physical damage to an opponent.

Mage: It features extremely low health points, extremely low defense power, extremely high attack power (i.e., magic damage), long attack range, inflexible movement, and being easily defeated. Therefore, an attack is usually performed on an enemy under the protection of a warrior.

Healer: It is positioned as a support role mainly responsible for providing healing and buff to teammates and ensuring continuous fighting power of a team. It is not good at frontline combats, but can make teammates more powerful by using various skills and means.

Phantom archer: It features extremely high physical damage, and is suitable for continuous output and remote attack.

Assassin: It features low health points, low defense power, high attack power, short attack range, and very flexible movement, and usually possesses many mobility skills.

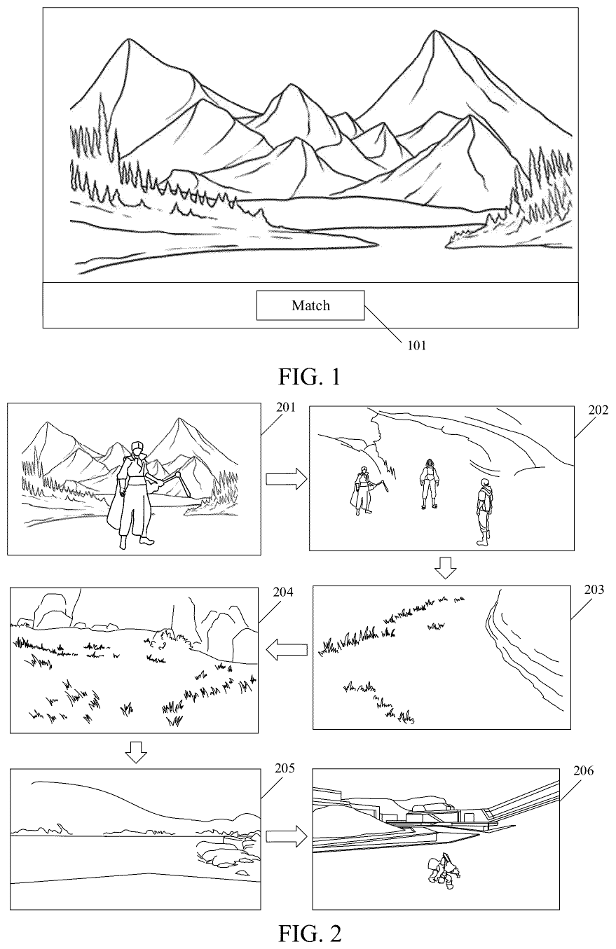

FIG. 1 is a schematic diagram of battle matching provided by some embodiments. As shown in FIG. 1, a matching option 101 is displayed on a battle matching interface. A player starts battle matching by triggering the matching option 101 or triggering a key corresponding to the matching option 101.

FIG. 2 is a schematic diagram of a game mode provided by some embodiments. As shown in FIG. 2, in an MMORPG game, after battle matching is successful, a character creation interface 201 is displayed, and a virtual object participating in a battle is created in the character creation interface 201, i.e., a virtual object of an identity type is selected to participate in a battle. After the virtual object is created, a lobby interface 202 is displayed. A plurality of virtual objects in matched teams are displayed on the lobby interface 202. A player may select, on the lobby interface, skills and the like carried by the virtual objects. After a game battle starts, a virtual scene interface 203 is displayed, which includes a first-tier virtual scene. After the game battle starts, all the virtual objects enter the first-tier virtual scene, and a task in the first-tier virtual scene is to explore an entrance to a second-tier virtual scene. After the entrance to the second-tier virtual scene is found, the virtual objects enter the second-tier virtual scene, and a virtual scene interface 204 is displayed. The virtual scene interface 204 includes the second-tier virtual scene, and a task in the second-tier virtual scene is to explore an entrance to a third-tier virtual scene. After the entrance to the third-tier virtual scene is found, the virtual objects enter the third-tier virtual scene, and a virtual scene interface 205 is displayed. The virtual scene interface 205 includes the third-tier virtual scene, and a task in the third-tier virtual scene is to explore an entrance to a fourth-tier virtual scene. After the entrance to the fourth-tier virtual scene is found, the virtual objects enter the fourth-tier virtual scene, and a virtual scene interface 206 is displayed. The virtual scene interface 206 includes the fourth-tier virtual scene. The fourth-tier virtual scene is a last-tier virtual scene which includes a gatekeeper boss for guarding an orb of silt. A task in the fourth-tier virtual scene is to defeat the gatekeeper boss, obtain the orb of silt, and find a final exit for extraction. In addition, the virtual scene of each tier further includes monsters and treasures therein, and a virtual object may dodge a monster attack and search for the treasures in the virtual scene.

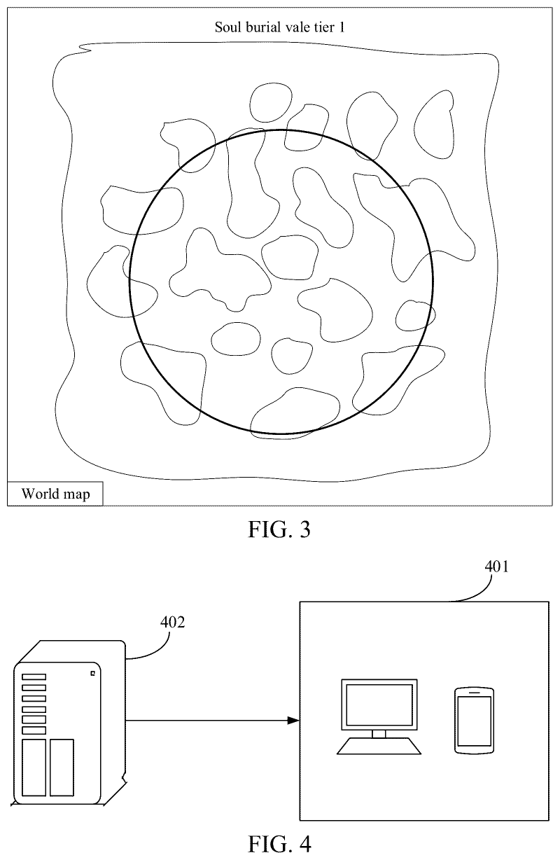

FIG. 3 is a schematic diagram of a virtual scene map provided by some embodiments. After a game battle starts, a virtual object manipulated by a player enters a first-tier virtual scene, and randomly appears at a spawn point on the map of the first-tier virtual scene. A game objective in the first-tier virtual scene is to search for an entrance to a second-tier virtual scene. In addition to monsters in the first-tier virtual scene, there is a threat from other players, and players may attack one another to loot virtual items. As shown in FIG. 3, the virtual scene map further has a blue zone mechanism therein. After a battle duration reaches a preset duration, blue zone shrinking starts to compress the living space for players, causing the players to move to a circular safe zone. An entrance to the second-tier virtual scene and an extraction point are both randomly refreshed in the safe area. The extraction point is a place for leaving the entire virtual scene, and may be construed as exiting the current virtual scene after extraction at the extraction point.

A method for controlling a virtual object provided by some embodiments may be applied to any scenario, e.g., applied to the aforementioned MMORPG game.

Virtual objects in a virtual scene have respective identity types. Different identity types correspond to different skills, and different virtual objects may attack one another. Taking a virtual object A and a virtual object B as an example, the virtual object A and the virtual object B have different identity types. Therefore, the virtual object A and the virtual object B possess different skills. After the virtual object A defeats the virtual object B, a primordial spirit (a virtual resource) dropped from the virtual object B is displayed, and by interacting with the primordial spirit, the virtual object A may obtain the skill of the virtual object B in the current round. For example, if a warrior wishes to obtain a blink skill of a mage, in the solution provided by some embodiments, the warrior kills a mage so that a virtual resource of the mage is dropped, and then interacts with the virtual resource to obtain the blink skill of the mage.

A skill of an identity skill is an inherent skill of a virtual object. In some embodiments, virtual objects not only can use the inherent skills of respective identity types, but also can obtain the inherent skills of virtual objects of other identity types. Compared with the related technology in which only a virtual item dropped from a virtual object can be picked up after the virtual object is defeated, in the solution of some embodiments, traits of the virtual objects of the other identity types can be learned, thereby enhancing playability.

In addition to being applied to the aforementioned MMORPG game, the method for controlling a virtual object provided by some embodiments may further be applied to games of other types such as multiplayer online battle arena (MOBA) games, first-person shooting (FPS) games, third-person shooting games, virtual reality games, or multiplayer survival games involving equipment.

An implementation environment for the technical solutions provided by some embodiments is described below.

FIG. 4 is a schematic diagram of an implementation environment of a method for controlling a virtual object provided by some embodiments. Referring to FIG. 1, the implementation environment may include a terminal 401 and a server 402 therein. The terminal 401 is connected to the server 402 through a wireless network or a wired network.

The server 402 provides a virtual scene for the terminal 401. The terminal 401 can display a virtual scene interface via the virtual scene provided by the server 402, can display virtual objects, virtual items, and the like in the virtual scene interface, and can control the virtual scene based on the virtual scene interface. The server 402 is configured to perform background processing according to control of the terminal 401 over the virtual scene, to provide background support for the terminal 401.

In some embodiments, the terminal 401 is installed with a game client which is a client provided by the server 402 or a client provided by an operating system of the terminal 401, or a client provided by a third party. The terminal 401 interacts with the server 402 via the game client. The game client may be any one of an MMORPG game, an MOBA game, a first-person shooting game, a third-person shooting game, a virtual reality application program, a three-dimensional map program, or a multiplayer survival game involving equipment. The terminal 401 may control the virtual object. A player uses the terminal 401 to operate a virtual object in the virtual scene in the virtual environment to perform an action. The action includes, but is not limited to, at least one of body posture adjustment, crawling, walking, running, jumping, picking, shooting, attacking, throwing, and skill casting.

In some embodiments, the terminal 401 is a smartphone, a tablet computer, a notebook computer, a desktop computer, a smart speaker, a smart television, a virtual reality (VR) device, an augmented reality (AR) device, or the like, but is not limited thereto. In some embodiments, the server 402 is an independent physical server, or a server cluster or a distributed system including a plurality of physical servers, or a cloud server that provides cloud computing services such as a cloud service, a cloud database, cloud computing, a cloud function, cloud storage, a network service, cloud communication, a middleware service, a domain name service, a security service, a content delivery network (CDN), and a big data and AI platform. In some embodiments, there may be a plurality of terminals 401 and a plurality of servers 402.

The method for controlling a virtual object provided by some embodiments is described below after the description of the implementation environment of some embodiments. The following description of the technical solutions provided in this application is made by taking as an example that the terminal serves as an execution body. In a further possible implementation, the technical solutions provided in this application may alternatively be jointly performed by the terminal and the server. A type of an execution body is not limited in some embodiments.

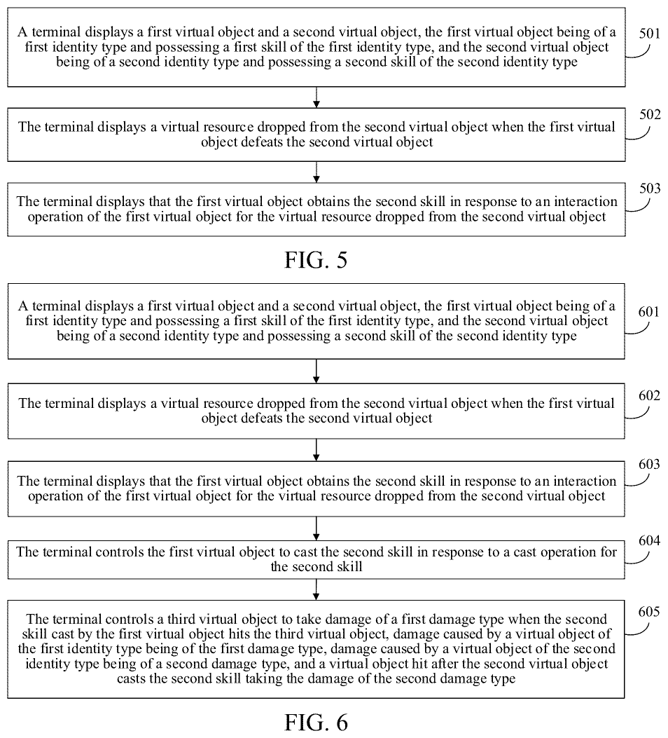

FIG. 5 is a flowchart of a method for controlling a virtual object provided by some embodiments. Referring to FIG. 5, taking as an example that an execution body is a terminal, the method includes the following operations.

501. The terminal displays a first virtual object and a second virtual object. The first virtual object is of a first identity type and possesses a first skill of the first identity type, and the second virtual object is of a second identity type and possesses a second skill of the second identity type.

A virtual scene includes the first virtual object and the second virtual object, and the terminal displays the first virtual object and the second virtual object. Each virtual object in the virtual scene has a respective identity type, and the identity type of the virtual object may be construed as a role of the virtual object in the virtual scene. Different identity types correspond to different skills. Therefore, virtual objects of different identity types possess skills of respective identity types. The skills of the respective identity types of the virtual objects are inherent skills of the virtual objects. After a virtual object of an identity type is selected to participate in a battle, the virtual object carries the skill of the identity type. The skill of the identity type is not obtained by the virtual object only by executing a particular task in a virtual scene, but is a skill carried in the identity type of the virtual object.

For example, in an MMORPG game, an identity type of a virtual object includes a warrior, a mage, a phantom archer, an assassin, a healer, and the like. The skills of the warrior include sundering, chopping, rotary chopping, and the like. The skills of the mage include icing, wind binding, linked lightning, thundering, and the like. The skills of the phantom archer include exploding arrow, multiple arrows, a trapping cage, flashing, and the like. The skills of the assassin include hundred ghost fangs, ghost hiding, ghost crying, and ghost shaving. The skills of the healer include azure dragon onslaught, withering spell, hualing spell, scapegoat spell, and the like. Different skills have different effects. For example, some skills may add buff to a virtual object, while some skills may cause damage to a hit virtual object, and damage effects caused by different skills are different.

In some embodiments, the identity type of the first virtual object is different from the identity type of the second virtual object. The first virtual object is of the first identity type which corresponds to the first skill, and thus possesses the first skill. The first skill is the inherent skill of the first virtual object. The second virtual object is of the second identity type which corresponds to the second skill, and thus possesses the second skill. The second skill is the inherent skill of the second virtual object.

The first virtual object and the second virtual object may belong to the same camp or may belong to different camps. The first virtual object and the second virtual object may be virtual objects controlled by user operations or virtual objects controlled by non-user operations. For example, the first virtual object and the second virtual object are both virtual objects controlled by the user operations. The first virtual object is a virtual object controlled by the local terminal, for example a main control virtual object, and the second virtual object is a virtual object controlled by another terminal.

502. The terminal displays a virtual resource dropped from the second virtual object when the first virtual object defeats the second virtual object.

When the first virtual object and the second virtual object make a game battle in the virtual scene, both parties may attack each other. If the first virtual object defeats the second virtual object, the virtual resource dropped from the second virtual object is displayed. For example, the virtual resource dropped from the second virtual object is displayed at a location where the second virtual object is defeated.

The first virtual object defeating the second virtual object refers to that the hit points (or health points) of the second virtual object are reduced to zero by attacking the second virtual object. In one embodiment, after the second virtual object is defeated by the first virtual object, the second virtual object is in a dead state. In one embodiment, when the second virtual object is in the dead state, the second virtual object may revive when meeting a reviving condition.

503. The terminal displays that the first virtual object obtains the second skill in response to an interaction operation of the first virtual object for the virtual resource dropped from the second virtual object.

After displaying the virtual resource dropped from the second virtual object, the terminal displays that the first virtual object obtains the second skill if the first virtual object performs the interaction operation for the virtual resource. The second skill is the inherent skill of the second virtual object of the second identity type and the first virtual object of the first identity type does not possess the second skill. However, in some embodiments, after defeating the second virtual object, the first virtual object of the first identity type may obtain the second skill of the second identity type by interacting with the virtual resource dropped when the second virtual object is defeated, so that the first virtual object of the first identity type can use the second skill of the second identity type. The limitation that a virtual object of each identity type can only use a respective skill is broken.

According to the method provided by some embodiments, virtual objects of different identity types possess different skills. The first virtual object of the first identity type possesses the first skill of the first identity type, and the second virtual object of the second identity type possesses the second skill of the second identity type. If the first virtual object defeats the second virtual object, the virtual resource dropped from the second virtual object is displayed. When the first virtual object interacts with the virtual resource, it is displayed that the first virtual object obtains the second skill of the second identity type. A virtual object of an identity type may obtain, by defeating virtual objects of other identity types, skills that the virtual objects of the other identity types possess. A limitation that a virtual object of each identity type can only use a respective skill is broken, which helps improve the flexibility of controlling a virtual object, and enhances a player's game experience.

The embodiment of FIG. 5 is a simple description of the method for controlling a virtual object provided by some embodiments. The following describes the method for controlling a virtual object provided by some embodiments more clearly in conjunction with some examples. FIG. 6 is a flowchart of another method for controlling a virtual object provided by some embodiments. Referring to FIG. 6, taking as an example that an execution body is a terminal, the method includes the following operations.

601. The terminal displays a first virtual object and a second virtual object. The first virtual object is of a first identity type and possesses a first skill of the first identity type, and the second virtual object is of a second identity type and possesses a second skill of the second identity type.

In some embodiments, the terminal displays a virtual scene interface. The virtual scene interface is configured to show a virtual scene which includes the first virtual object and the second virtual object. Therefore, the virtual scene interface displays the first virtual object and the second virtual object therein.

In one embodiment, the first virtual object is a virtual object controlled by the local terminal, for example a virtual object controlled by an account currently logged into on the terminal. The virtual scene interface is configured to display the virtual scene within a view angle range of the first virtual object. The virtual scene may further include a river, grass, land, a building, and the like therein. The virtual scene interface may include a minimap, other action buttons, a virtual joystick area, other control buttons, and the like. The virtual joystick area is configured to control a virtual object to walk and run in the virtual scene, and adjust a view angle direction of the virtual object. A plurality of action buttons are configured to control a virtual object to perform corresponding actions in the virtual scene. The minimap displays a location of the virtual object in the virtual scene so that a player can control the virtual object via the virtual scene interface.

602. The terminal displays a virtual resource dropped from the second virtual object when the first virtual object defeats the second virtual object.

When the first virtual object and the second virtual object make a game battle in the virtual scene, both parties may attack each other. If the first virtual object defeats the second virtual object, the virtual resource dropped from the second virtual object is displayed.

In some embodiments, the virtual resource dropped from the second virtual object is associated with the second identity type of the second virtual object. In one embodiment, the virtual resource is generated based on the second identity type. This may be construed as different identity types corresponding to different virtual resources. Virtual resources dropped when virtual objects of different identity types are defeated are different. For example, forms of virtual resources corresponding to different identity types are different, or types of virtual resources corresponding to different identity types are different.

In some embodiments, the virtual resource dropped from the second virtual object may be in any form. In one embodiment, the virtual resource is a virtual image that can represent the second identity type of the second virtual object. Virtual images corresponding to different identity types are different. For example, in an MMORPG game, the current virtual scene is an ancient myth world. Virtual objects in the virtual scene have respective identity types, and the virtual objects of different identity types have different images. For example, a warrior has a relatively large size, while a healer has a relatively small size, and so on. In addition, the virtual objects in the virtual scene further have primordial spirits. The primordial spirit is a virtual material that exists alone beyond a body in the domain of myths. The primordial spirit of a virtual object is the same as an image of the virtual object, but the transparency of the primordial spirit of the virtual object is greater than that of the virtual object. The virtual resource dropped when the second virtual object is defeated may be the primordial spirit of the second virtual object. For another example, the virtual resource may alternatively be a virtual pet of the second virtual object or the like.

In some embodiments, the terminal displays the virtual resource dropped from the second virtual object and displays the second identity type at the location of the virtual resource when the first virtual object defeats the second virtual object. In one embodiment, the terminal displays the second identity type above, below, on the left side of, or on the right side of the virtual resource. For example, if the second identity type of the second virtual object is phantom archer, “primordial spirit of phantom archer” is displayed above the virtual resource dropped from the second virtual object.

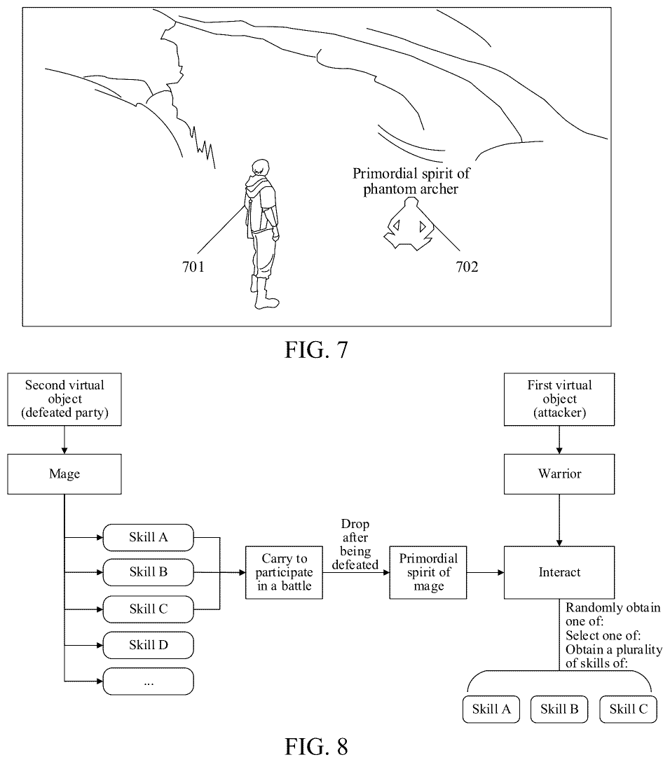

FIG. 7 is a schematic diagram of a virtual scene interface provided by some embodiments. Taking an MMORPG game as an example, the identity type of the second virtual object is phantom archer, and the virtual resource dropped when the second virtual object is defeated is the primordial spirit of the second virtual object. The virtual scene interface shown in FIG. 7 displays the first virtual object 701 and the primordial spirit 702 dropped from the second virtual object, and “primordial spirit of phantom archer” is displayed above the primordial spirit 702 of the second virtual object. When seeing the “primordial spirit of phantom archer” displayed above the primordial spirit 702 of the second virtual object, a player may know that the player can obtain the skill of the phantom archer by interacting with the primordial spirit 702.

In some embodiments, while the virtual resource dropped when the second virtual object is defeated is displayed, the second identity type of the second virtual object is further correspondingly displayed. Another player may know from the displayed second identity type that the skill of the second identity type can be obtained by interacting with the virtual resource, and thus can determine whether the skill of the second identity type is needed according to an actual situation, so as to interact with the virtual resource when the skill of the second identity type is needed, and not interact with the virtual resource when the skill of the second identity type is not needed. This is conducive to helping a player to make a battle decision and improves the convenience of a game battle.

In some embodiments, in a virtual scene, each identity type may correspond to a plurality of different skills. In a battle, each virtual object possesses one or more of all skills of a respective identity type. A skill of a respective identity type to be carried by each virtual object may be selected by a player or randomly allocated by a server. For example, an identity type corresponds to five skills, and a virtual object of the identity type carries at most three skills of the identity type in each battle. Therefore, the player may select three skills to carry, or the server randomly allocates three skills. Therefore, a virtual object of the same identity type may possess the same skill or different skills in different battles.

In this implementation, after defeating the second virtual object, the first virtual object can only obtain a skill carried by the second virtual object in the current battle, but cannot obtain a skill not carried by the second virtual object in the current battle. Therefore, the virtual resource dropped when the second virtual object is defeated is associated with skill information of the second virtual object. The skill information is configured for indicating a skill carried by the second virtual object in the current battle. Therefore, after subsequently performing the interaction operation for the virtual resource, the first virtual object can only obtain the skill indicated by the skill information associated with the virtual resource. In one embodiment, the virtual resource dropped when the second virtual object is defeated is associated with both identity type information and skill information of the second virtual object. The second identity type of the second virtual object may be displayed at the location of the virtual resource based on the identity type information, and the skill carried by the second virtual object in the current battle may be endowed to the first virtual object based on the skill information.

603. The terminal displays that the first virtual object obtains the second skill in response to an interaction operation of the first virtual object for the virtual resource dropped from the second virtual object.

After displaying the virtual resource dropped from the second virtual object, the terminal displays that the first virtual object obtains the second skill, i.e., obtains the skill of the second identity type, if the first virtual object performs the interaction operation for the virtual resource.

In some embodiments, as described in operation 602 above, the second identity type corresponds to a plurality of skills, and the second skill that the second virtual object possesses is one or more of all skills of the second identity type. The virtual resource dropped when the second virtual object is defeated is associated with skill information of the second virtual object, and the skill information is configured for indicating the second skill carried by the second virtual object in the current battle. The terminal displays that the first virtual object obtains the second skill indicated by the skill information in response to the interaction operation of the first virtual object for the virtual resource.

In some embodiments, the virtual resource dropped when the second virtual object is defeated is associated with the second skill of the second virtual object, so that after defeating the second virtual object, the first virtual object can only obtain the skill carried by the second virtual object in the present battle, but cannot obtain the skill not carried by the second virtual object in the present battle. Therefore, it is simulated that the first virtual object “steals” the skill that the second virtual object currently possesses, so that the way of learning a skill by a virtual object across identity types is not abrupt. Modes of interaction between virtual objects are more vivid, thereby improving interest and authenticity.

In some embodiments, the second virtual object possesses a plurality of second skills of the second identity type. The process in which the terminal displays that the first virtual object obtains the second skill in response to the interaction operation of the first virtual object for the virtual resource dropped from the second virtual object includes any one of the following three obtaining modes.

In first obtaining mode, the terminal displays a skill selection list including a plurality of second skills in response to the interaction operation of the first virtual object for the virtual resource dropped from the second virtual object, and displays that the first virtual object obtains a selected second skill in response to a select operation for any second skill.

When the second virtual object possesses a plurality of second skills of the second identity type, the player controlling the first virtual object selects which second skill to obtain, so that the player can make a decision according to a requirement of the player. Thus, the flexibility of obtaining a skill is improved.

In a second obtaining mode, the terminal randomly determines a second skill among the plurality of second skills in response to the interaction operation of the first virtual object for the virtual resource dropped from the second virtual object, and displays that the first virtual object obtains the randomly determined second skill.

When the second virtual object possesses a plurality of second skills of the second identity type, one of the plurality of second skills is randomly allocated to the first virtual object. Thus, the diversity and randomness of obtaining a skill by the first virtual object are improved, thereby urging a player to flexibly make a flexible according to the currently allocated second skill. Hence, the interest of a game battle is improved.

In a third obtaining mode, the terminal displays that the first virtual object obtains the plurality of second skills in response to the interaction operation of the first virtual object for the virtual resource dropped from the second virtual object.

When the second virtual object possesses a plurality of second skills of the second identity type, the first virtual object may obtain all second skills that the second virtual object possesses currently. Thus, benefits brought by defeating a virtual object are increased, thereby urging players to control virtual objects to actively interact with one another. Hence, the efficiency of human-computer interaction is improved.

FIG. 8 is a schematic diagram of a skill obtaining mode provided by some embodiments. As shown in FIG. 8, the identity type of the first virtual object is warrior, and the identity type of the second virtual object is mage. Skills of the mage include a skill A, a skill B, a skill C, a skill D, and the like. The second virtual object carries the skill A, the skill B, and the skill C to participate in a battle. The first virtual object is an attacker, and the second virtual object is a defeated party. After the second virtual object is defeated, the primordial spirit of the mage is dropped. The first virtual object may obtain at least one of the skill A, the skill B, or the skill C of the mage by interacting with the primordial spirit of the mage. For example, one of the three skills may be randomly obtained, or one of the three skills may be selected to be obtained, or the three skills may be simultaneously obtained.

In some embodiments, the process in which the terminal displays that the first virtual object obtains the second skill in response to the interaction operation of the first virtual object for the virtual resource dropped from the second virtual object includes any one of the following three interaction modes.

In a first interaction mode, the terminal displays that the first virtual object obtains the second skill in response to the first virtual object touching the virtual resource dropped from the second virtual object.

The interaction operation of the first virtual object for the virtual resource is the first virtual object touching the virtual resource. The player manipulates the first virtual object to move toward the virtual resource, and when the first virtual object comes into contact with the virtual resource, the first virtual object touches the virtual resource.

In a second interaction mode, the terminal displays that the first virtual object obtains the second skill in response to a trigger operation for an interactive option when a distance between the first virtual object and the virtual resource dropped from the second virtual object is less than a distance threshold.

The interactive option is an option for interacting with the virtual resource dropped from the second virtual object.

The interaction operation of the first virtual object for the virtual resource is a trigger operation for the interactive option of the virtual resource. The player manipulates the first virtual object to move toward the virtual resource. When the distance between the first virtual object and the virtual resource is less than the distance threshold, if the player performs the trigger operation for the interactive option, the first virtual object may obtain the second skill of the second virtual object.

In one embodiment, the interactive option of the virtual resource is a triggerable interactive control displayed on the terminal. Exemplarily, the player manipulates the first virtual object to move toward the virtual resource. When the distance between the first virtual object and the virtual resource is less than the distance threshold, the terminal displays the interactive control beside the virtual resource. When the distance between the first virtual object and the virtual resource is not less than the distance threshold, the display of the interactive control is canceled.

In one embodiment, the interactive option of the virtual resource is a real physical key. For example, the interactive option is a key on a keyboard or a key on a gamepad. The player manipulates the first virtual object to move toward the virtual resource. When the distance between the first virtual object and the virtual resource is less than the distance threshold, interaction prompt information is displayed. The interaction prompt information includes a key identifier of an interaction key, and the player may determine which key to trigger to interact with the virtual resource via the key identifier.

In some embodiments, the terminal plays back an interaction animation in response to the interaction operation of the first virtual object for the virtual resource dropped from the second virtual object, and displays that the first virtual object obtains the second skill after the playback of the interaction animation is finished.

The interaction animation is an animation that the first virtual object interacts with the virtual resource. For example, the virtual resource is the primordial spirit dropped when the second virtual object is defeated, and the interaction animation is an animation that the primordial spirit is taken up by the first virtual object.

In some embodiments, by displaying the interaction animation, on the one hand, game pictures can be enriched, and on the other hand, a player can be reminded of a successful interaction, which is conducive to improving the game experience of the player.

In some embodiments, after defeating the second virtual object, in addition to obtaining the second skill of the second virtual object, the first virtual object may further obtain a second virtual item dropped from the second virtual object. The process in which the terminal displays that the first virtual object obtains the second skill in response to the interaction operation of the first virtual object for the virtual resource includes: displaying that the first virtual object obtains the second skill and the second virtual item in response to the interaction operation of the first virtual object for the virtual resource dropped from the second virtual object. The second virtual item is dropped when the second virtual object is defeated.

The second virtual item dropped when the second virtual object is defeated is picked up by the second virtual object in the virtual scene. For example, the virtual item includes a virtual cutter, a virtual potion, a virtual prop for leveling up, and the like. A difference between the second virtual item and the second skill of the second virtual object lies in that the second skill is a virtual resource inherent to the second virtual object and may be obtained with no may perform a operation, while the second virtual item is not a virtual resource inherent to the second virtual object and may be obtained by performing a operation later. The second skill may be construed as a trait of the second virtual object, while the second virtual item may be construed as an “external thing” for the second virtual object.

For example, in an MMORPG game, the current virtual scene is an ancient myth world. After being defeated, the second virtual object of the second identity type drops the primordial spirit of the second identity type. The primordial spirit not only bears the second skill that the second virtual object possesses, but also bears the second virtual item carried by the second virtual object. After the second virtual object is defeated, the second virtual object currently carried is dropped. After the first virtual object interacts with the primordial spirit dropped from the second virtual object, the first virtual object not only can obtain the second skill born by the primordial spirit, but also can obtain the second virtual item born by the primordial spirit.

In some embodiments, after defeating the second virtual object, in addition to obtaining the second skill of the second virtual object, the first virtual object may further obtain the virtual item dropped from the second virtual object. Thus, benefits brought by defeating a virtual object are increased, thereby urging players to control virtual objects to actively interact with one another. Hence, the efficiency of human-computer interaction is improved.

In some embodiments, after the first virtual object performs the interaction operation for the virtual resource dropped from the second virtual object, the terminal cancels the display of the virtual resource dropped from the second virtual object. Thus, an effect that the first virtual object picks up the virtual resource dropped from the second virtual object is stimulated.

604. The terminal controls the first virtual object to cast the second skill in response to a cast operation for the second skill.

After obtaining the second skill of the second virtual object, the first virtual object may control the first virtual object to cast the second skill. The second skill may be an attack skill, a healing skill, a buff skill, or the like. This is not limited in some embodiments.

In some embodiments, different identity types correspond to different virtual props. For example, a virtual prop of a warrior is a virtual big sword, and a virtual item of a mage is a virtual wand. Different identity types further correspond to different action modules. For example, an action in an action module of a warrior includes swinging a sword, and an action in an action module of a mage includes casting a spell. In some embodiments, the first virtual object holds a first virtual prop of the first identity type; the second virtual object holds a second virtual prop of the second identity type; the second skill corresponds to a target action identifier; and an action indicated by the target action identifier is an action to be performed when casting the second skill. The target action identifier indicates a first action in an action module of the first identity type and further indicates a second action in an action module of the second identity type. Then, when casting the second skill, the second virtual object holds the second virtual prop to perform the second action.

The process in which the terminal controls the first virtual object to cast the second skill in response to the cast operation for the second skill includes: controlling the first virtual object to cast the second skill and hold the first virtual prop to perform the first action in response to the cast operation for the second skill.

Since the identity types of the first virtual object and the second virtual object are different, the virtual props held by and actions that can be made by the first virtual object and the second virtual object are different. The second skill is the inherent skill of the second virtual object. The second virtual item is held to perform the second action when the second skill is cast. However, the first virtual object does not have the second virtual prop and cannot perform the second action. Therefore, after the first virtual object obtains the second skill of the second virtual object, the virtual prop and the action of the first virtual object may be adapted when the second skill is cast. Therefore, unlike the second virtual object, the first virtual object holds the first virtual prop to perform the first action when casting the second skill.

For example, the first virtual object is a warrior and the virtual prop of the first virtual object is a virtual big sword. The second virtual object is a mage and the virtual prop of the second virtual object is a virtual wand. The second skill of the second virtual object is casting a fireball. The target action identifier of the second skill indicates a sword swinging action in the action module of the warrior and indicates a spell casting action in the action module of the mage. The process in which the second virtual object casts the second skill includes: holding the virtual wand and performing the spell casting action to cast a fireball. The process in which the first virtual object casts the second skill includes: holding the virtual big sword and performing the sword swinging action to cast a fireball.

In some embodiments, virtual props and actions of the first identity type and the second identity type are different. The second virtual object holds the second virtual prop to perform the second action when casting the second skill, while the first virtual object holds the first virtual prop to perform the first action when casting the second skill, so that the process in which the first virtual object casts the second skill can be adapted to the virtual prop and the action of the first identity type. Thus, a virtual object can successfully use skills of other identity types, thereby ensuring the implementability of the solution of obtaining a skill across identity types.

In some embodiments, the second skill further corresponds to a skill effect. The second virtual object displays the skill effect when casting the second skill. The process in which the terminal controls the first virtual object to cast the second skill in response to the cast operation for the second skill includes: controlling the first virtual object to cast the second skill and displaying the skill effect in response to the cast operation for the second skill effect.

For example, the first virtual object is a warrior and the second virtual object is a mage. The second skill of the second virtual object is casting a fireball and the skill effect of the second skill is flickering of flame. Then, there is flame flickering around the second virtual object when casting the second skill, and there is also flame flickering around the first virtual object when casting the second skill.

The above two implementations may be combined with each other. The second virtual object holds the second virtual prop to perform the second action and displays the skill effect when casting the second skill, and the first virtual object holds the first virtual prop to perform the first action and display the skill effect when casting the second skill.

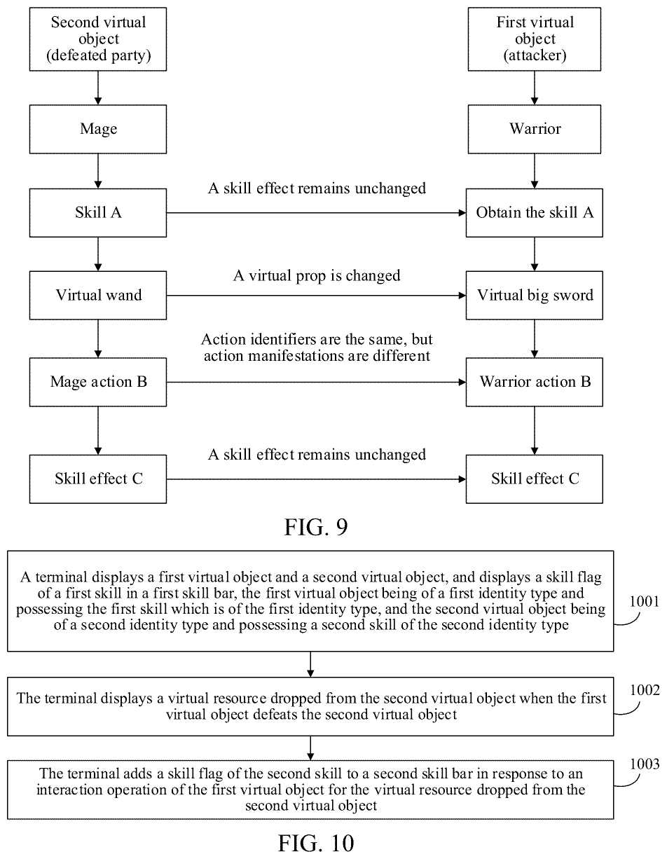

FIG. 9 is a schematic diagram of a skill adapting method provided by some embodiments. As shown in FIG. 9, the first virtual object is a warrior and the second virtual object is a mage. The second skill of the second virtual object is a skill A, and the first virtual object may obtain the skill A after defeating the second virtual object. A skill effect produced when the warrior casts the skill A is the same as a skill effect produced when the mage casts the skill A. The mage holds a wand when casting the skill A, and the warrior holds a big sword when casting the skill A. The mage performs a mage action B when casting the skill A, and the warrior performs a warrior action B when casting the skill A. Action identifiers are the same, but action manifestations are different. The skill effect displayed when the warrior casts the skill A is the same as the skill effect displayed when the mage casts the skill A.

In some embodiments, each skill in the virtual scene corresponds to a configuration file of each identity type. When a virtual object of an identity type casts a skill, a skill casting process is implemented via the configuration file of the identity type corresponding to the skill. For example, the virtual scene includes therein five identity types: an identity type 1 to an identity type 5, where the identity type 1 corresponds to a skill A which is an inherent skill of the identity type. The skill A corresponds to configuration files of the identity type 1 to the identity type 5. The skill A corresponds to five configuration files. In some embodiments, the first virtual object is of the first identity type and the second virtual object is of the second identity type. The second virtual object possesses the second skill of the second identity type, and the second skill corresponds to a configuration file of each identity type. The second skill is an inherent skill of the second virtual object. After defeating the second virtual object, the first virtual object may obtain the second skill.

An implementation process of casting the second skill by the second virtual object includes: obtaining a configuration file of the second identity type from a plurality of configuration files corresponding to the second skill in response to a cast operation of the second virtual object for the second skill, and controlling the first virtual object to cast the second skill based on the configuration file of the second identity type. An implementation process of casting the second skill by the first virtual object includes: obtaining a configuration file of the first identity type in the plurality of configuration files corresponding to the second skill in response to a cast operation of the first virtual object for the second skill, and controlling the first virtual object to cast the second skill based on the configuration file of the first identity type.

In one embodiment, a prop identifier, a target action identifier, an effect identifier, and the like are specified in a configuration file corresponding to a skill. For example, in the configuration file of the first identity type corresponding to the second skill, the prop identifier indicates a virtual prop (i.e., the first virtual prop) of the first identity type, the target action identifier indicates an action (i.e., the first action) in the action module of the first identity type, and the effect identifier indicates the skill effect of the second skill. In the configuration file of the second identity type corresponding to the second skill, the prop identifier indicates a virtual prop (i.e., the second virtual prop) of the second identity type, the target action identifier indicates an action (i.e., the second action) in the action module of the second identity type, and the effect identifier indicates second skill effect of the second skill.

605. The terminal controls a third virtual object to take damage of a first damage type when the second skill cast by the first virtual object hits the third virtual object, where damage caused by a virtual object of the first identity type is of the first damage type; damage caused by a virtual object of the second identity type is of a second damage type; and a virtual object hit after the second virtual object casts the second skill takes the damage of the second damage type.

Since the identity types of the first virtual object and the second virtual object are different, the types of damage caused by the first virtual object and the second virtual object are different. The damage caused by the virtual object of the first identity type is of the first damage type, and the damage caused by the virtual object of the second identity type is of the second damage type. The second skill is an inherent skill of the second virtual object, and the damage of the second damage type may be caused when the second skill is cast. However, the first virtual object cannot cause the damage of the second damage type. Therefore, after the first virtual object obtains the second skill of the second virtual object, the type of the damage that can be caused by the first virtual object may be adapted when the second skill is cast. Therefore, unlike the second virtual object, the first virtual object may cause the damage of the first damage type when casting the second skill.

For example, the first virtual object is a warrior and the first damage type is physical damage. The second virtual object is a mage and the second damage type is magic damage. Then, the magic damage may be caused after the second virtual object casts the second skill, and the physical damage may be caused after the first virtual object casts the second skill.

In some embodiments, the damage types corresponding to the first identity type and the second identity type are different. The second virtual object causes the damage of the second damage type when casting the second skill, while the first virtual object causes the damage of the first damage type when casting the second skill, so that the process in which the first virtual object casts the second skill can be adapted to the damage type corresponding to the first identity type. Thus, a virtual object can successfully use skills corresponding to other identity types, thereby ensuring the implementability of the solution of obtaining a skill across identity types.

According to the method provided by some embodiments, virtual objects of different identity types possess different skills. The first virtual object of the first identity type possesses the first skill of the first identity type, and the second virtual object of the second identity type possesses the second skill of the second identity type. If the first virtual object defeats the second virtual object, the virtual resource dropped from the second virtual object is displayed. When the first virtual object interacts with the virtual resource, it is displayed that the first virtual object obtains the second skill. A virtual object of an identity type may obtain, by defeating virtual objects of other identity types, skills that the virtual objects of the other identity types possess. A limitation that a virtual object of each identity type can only use a respective skill is broken, which helps improve the flexibility of controlling a virtual object, and enhances a player's game experience.

Also, in a battle, a virtual object of each identity type not only can use a fixed skill of the identity type, but also can obtain skills of other identity types by defeating virtual objects, and when the skills of the other identity types are used, the virtual props and actions of the virtual objects and the types of damage caused by the same can all be adapted to the identity type of the current virtual object. The playability of a game battle is greatly improved.

In some embodiments, after the first virtual object defeats the second virtual object and a virtual resource dropped from the second virtual object is displayed, the first virtual object may not interact with the virtual resource, and instead give the virtual resource to another virtual object. The terminal displays an object list in response to a giving operation of the first virtual object for the virtual resource dropped from the second virtual object. The object list includes an object identifier of at least one friendly virtual object, and the friendly virtual object is a virtual object belonging to the same team as the first virtual object. The terminal displays that a fourth virtual object obtains the second skill in response to a select operation for any object identifier in the object list, where the fourth virtual object is a virtual object indicated by the selected object identifier.

Alternatively, after the virtual resource dropped from the second virtual object is displayed, the first virtual object may not interact with the virtual resource, and does not may perform the giving operation for the virtual resource. Instead, a friendly virtual object performs an interaction operation for the virtual resource. After the friendly virtual object performs the interaction operation for the virtual resource, the friendly virtual object obtains the second skill.

In some embodiments, after the first virtual object defeats the second virtual object, the virtual resource dropped from the second virtual object may be transferred to another virtual object in the same team. For example, when the first virtual object is sufficiently powerful, the dropped virtual resource is transferred to another virtual object, thereby improving the overall capability of the entire team. For another example, when the second skill of the second identity type is not suitable for the first virtual object, the dropped virtual resource may be transferred to another virtual object suitable for the second skill. Therefore, a player may develop different battle policies according to different situations in a battle, thereby helping ensure the flexibility of the game battle.

In some embodiments, when the first virtual object obtains the second skill, a skill obtaining message is transmitted by a server to each terminal participating in the current battle, and the terminals display the skill obtaining message. The skill obtaining message is configured for representing that the first virtual object obtains the second skill. After a virtual object obtains skills of other virtual objects, the virtual object can make a global prompt in the game battle to remind other players of which skills the virtual object possesses, so that the other players can adjust battle policies in time for this case, thereby ensuring fairness of the game battle and being conducive to improving the game experience of the players.

In some embodiments, after the first virtual object obtains the second skill, the terminal displays that the second skill obtained by the first virtual object is taken back in response to that a number of times the first virtual object casts the second skill reaches a preset number of times. A number of uses of a skill obtained by a virtual object is limited. The number of uses of the skill by the virtual object is the preset number of times at most. When the number of uses reaches the preset number of uses, the skill cannot be used again.

Alternatively, after the first virtual object obtains the second skill, the terminal displays that the second skill obtained by the first virtual object is taken back in response to a duration of the first virtual object obtaining the second skill reaching a preset duration. A duration of possession of a skill obtained by a virtual object is limited. A duration of possession of a skill by a virtual object is a preset duration at most. When the duration of possession reaches the preset duration, the skill cannot be used again.

In some embodiments, the number of uses or the duration of possession of the second skill of the second virtual object obtained by the first virtual object is limited so that the first virtual object cannot use the second skill unlimitedly, avoiding that fighting powers of some virtual objects are excessively high continuously. Therefore, based on rich battle play methods, the fighting powers of the virtual objects in a game battle can further be effectively balanced, thereby helping ensure the game battle experience of the players.

In some embodiments, when a number of skills obtained by the first virtual object in the current battle does not reach a preset number, the terminal displays that the first virtual object obtains the second skill in response to an interaction operation of the first virtual object for a virtual resource dropped from the second virtual object. When the number of skills obtained by the first virtual object in the current battle reaches the preset number, the terminal displays a skill obtaining failure message in response to the interaction operation of the first virtual object for the virtual resource dropped from the second virtual object. The number of skills that can be obtained by a virtual object in the same battle is limited. The number of skills that can be obtained by the same virtual object is the preset number at most, and if the number reaches the preset number, skills of other virtual objects can no longer be obtained. In one embodiment, the preset number may be one, two, or the like.

In some embodiments, the number of skills obtained by the first virtual object is limited so as to avoid a problem that fighting powers of virtual objects in a game battle are seriously imbalanced due to an excess of skills possessed by a virtual object, thereby ensuring the game battle experience of the players.

In some embodiments, when the first virtual object has obtained a third skill, the terminal displays that the third skill the first virtual object has obtained is replaced with the second skill in response to an interaction operation of the first virtual object for a virtual resource dropped from the second virtual object. The third skill is obtained when the first virtual object interacts with a virtual resource dropped from a third virtual object. The third virtual object is of a third identity type and possesses the third skill of the third identity type. The third identity type is different from the first identity type of the first virtual object.

In some embodiments, when the first virtual object has obtained the third skill of another virtual object, if a new second skill may be obtained currently, the obtained third skill is replaced with the currently obtained new second skill to ensure that the first virtual object can only obtain one skill of the another virtual object at the same time. A player may determine whether to pick up a new skill to replace the skill picked up previously according to an actual situation. Not only can the fighting powers of virtual objects in a game battle be effectively balanced, but also the player can be aroused to flexibly develop a battle policy, thereby improving the autonomy of the player in the game battle.

In the foregoing embodiments, a skill obtained by a virtual object is a skill of another virtual object obtained by the virtual object, rather than the inherent skill of the virtual object.

In some embodiments, the terminal displays a skill bar of the first virtual object. The skill bar is configured to show a skill flag of a skill that the first virtual object possesses and includes a skill flag of the first skill. Then, the process in which the terminal displays that the first virtual object obtains the second skill in response to the interaction operation of the first virtual object for the virtual resource dropped from the second virtual object includes: adding a skill flag of the second skill to the skill bar in response to the interaction operation of the first virtual object for the virtual resource dropped from the second virtual object.

The skill flag may be a skill name, a skill pattern, or the like. If a skill flag is shown in the skill bar of the first virtual object, the first virtual object possesses the skill indicated by the skill flag. Therefore, after the first virtual object interacts with the virtual resource, the skill flag of the second skill is added to the skill bar to indicate that the first virtual object obtains the second skill.

In some embodiments, the skill bar includes a first skill bar configured to show a skill flag of a skill of the first identity type that the first virtual object possesses and a second skill bar configured to show skill flags of skills of other identity types that the second virtual object possesses, where the other identity types refer to identity types other than the first identity type. If a skill flag is shown in the first skill bar of the first virtual object, the first virtual object possesses the skill indicated by the skill flag, and the skill is of the first identity type, for example the inherent skill of the first virtual object. If a skill flag is shown in the second skill bar of the first virtual object, the first virtual object possesses the skill indicated by the skill flag, and the skill is a skill of another identity type other than the first identity type, for example a skill of another identity type obtained by the first virtual object.

Based on this, for a detailed process of the method for controlling a virtual object, refer to the following embodiment shown in FIG. 10. FIG. 10 is a flowchart of another method for controlling a virtual object provided by some embodiments. Some embodiments is performed by a terminal. Referring to FIG. 10, the method includes the following operations.

1001: The terminal displays a first virtual object and a second virtual object, and displays a skill flag of a first skill in a first skill bar. The first virtual object is of a first identity type and possesses the first skill which is of the first identity type. The second virtual object is of a second identity type and possesses a second skill of a second identity type.

The first skill bar is configured to show a skill flag of a skill of the first identity type that the first virtual object possesses. The first skill bar is configured to show an inherent skill of the first virtual object and the first skill is the inherent skill of the first virtual object. Therefore, the first skill bar includes the skill flag of the first skill therein.

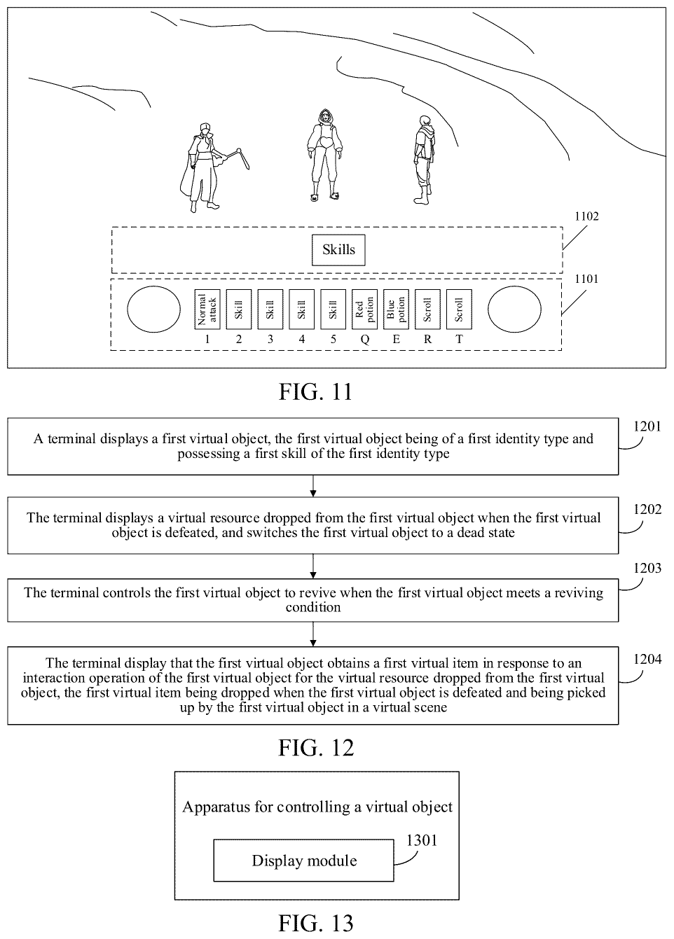

FIG. 11 is a schematic diagram of another virtual scene interface provided by some embodiments. As shown in FIG. 11, a first skill bar 1101 is displayed in the virtual scene interface. The first skill bar includes a skill flag of the inherent skill of the first virtual object, for example the skill flag of the skill of the first identity type.

1002. The terminal displays a virtual resource dropped from the second virtual object when the first virtual object defeats the second virtual object.

The process of displaying the virtual resource dropped from the second virtual object in operation 1002 is similar to the process of displaying the virtual resource dropped from the second virtual object in operation 602 described above, which will not be described redundantly here.

1003. The terminal adds a skill flag of the second skill to a second skill bar in response to an interaction operation of the first virtual object for the virtual resource dropped from the second virtual object.

The second skill bar is configured to show a skill flag of a skill of another identity type that the first virtual object possesses, and the another identity type refers to an identity type other than the first identity type. The second skill is a skill of the second identity type rather than the inherent skill of the first virtual object. Therefore, the skill flag of the second skill is added to the second skill bar to represent that the first virtual object obtains the second skill.

As shown in FIG. 11, a second skill bar 1102 is displayed in the virtual scene interface. The second skill bar includes the skill flag of the second skill obtained by the first virtual object.

According to the method by some embodiments, the skill flag of the skill of the first identity type that the first virtual object possesses is shown in the first skill bar, and the skill flag of the skill of another identity type that is obtained by the first virtual object is shown in the second skill bar, such that the inherent skill of the first virtual object is distinguished from a skill obtained in a battle.

In some embodiments, a virtual object in a virtual scene may revive after being defeated. Taking as an example that the first virtual object revives after being defeated, for a detailed process, refer to the following embodiment shown in FIG. 12. FIG. 12 is a flowchart of another method for controlling a virtual object provided by some embodiments. Some embodiments is performed by a terminal. Referring to FIG. 12, the method includes the following operations.

1201. The terminal displays a first virtual object. The first virtual object is of a first identity type and possesses a first skill of the first identity type.

A process of operation 1201 is similar to the process of the foregoing operation 601, which will not be described redundantly here.

1202. The terminal displays a virtual resource dropped from the first virtual object when the first virtual object is defeated, and switches the first virtual object to a dead state.

After the first virtual object is defeated, the virtual resource dropped from the first virtual object is displayed at a location where the first virtual object is defeated, and the first virtual object is switched to the dead state. The first virtual object in the dead state drops a carried virtual item, and the dropped virtual object is born in the virtual resource. In addition, the virtual resource dropped from the first virtual object further bears a skill of the first identity type that the first virtual object possesses. Subsequently, another virtual object may obtain the skill or the virtual item born by the virtual resource after interacting with the virtual resource dropped from the first virtual object. The virtual resource dropped from the first virtual object is similar to the virtual resource dropped from the second virtual object in the foregoing embodiments, which will not be described redundantly here.

In some embodiments, the first virtual object in the dead state cannot perform an operation in the virtual scene. Alternatively, the first virtual object in the dead state may move in the virtual scene, but cannot interact with other virtual objects, virtual items, or the like in the virtual scene.

1203. The terminal controls the first virtual object to revive when the first virtual object meets a reviving condition.

When the first virtual object in the dead state meets the reviving condition, the first virtual object revives again, i.e., exits the dead state, and then may continue to participate in the battle in the virtual scene.

In some embodiments, the first virtual object in the dead state can only move in the virtual scene, but cannot interact with the virtual objects and the virtual items in the virtual scene. The virtual scene includes a reviving point, and the reviving condition is that the first virtual object moves to the reviving point. Therefore, after the first virtual object in the dead state moves to the reviving point, the first virtual object is controlled to revive. In one embodiment, when the first virtual object moves to the reviving point, upon detecting a revive operation for the first virtual object, the first virtual object is controlled to revive.

In some embodiments, the virtual scene includes a reviving point, and the first virtual object in the dead state may be automatically teleported to the reviving point, cannot perform a move operation, and cannot interact with the virtual objects and the virtual items in the virtual scene.

The reviving condition is that a duration of the first virtual object being in the dead state reaches a preset duration. Therefore, when the duration of the first virtual object being in the dead state reaches the preset duration, the first virtual object is controlled to revive at the reviving point.

1204. The terminal display that the first virtual object obtains a first virtual item in response to an interaction operation of the first virtual object for the virtual resource dropped from the first virtual object. The first virtual item is dropped when the first virtual object is defeated and is picked up by the first virtual object in the virtual scene.

In some embodiments, if the virtual resource dropped when the first virtual object is defeated is not interacted by any virtual object, i.e., not picked up by any virtual object, the virtual resource is always displayed in the virtual scene. After the first virtual object revives, a player may control the first virtual object to interact with the virtual resource, thereby re-obtaining the virtual item dropped when the first virtual object is defeated.

The virtual resource dropped from the first virtual object further bears the first skill of the first virtual object. However, since the first skill is the inherent skill of the first virtual object, the first virtual object still possesses the first skill after being defeated, the first virtual object only may re-obtain the first virtual item dropped when the first virtual object is defeated after the first virtual object interacts with the virtual resource dropped from the first virtual object, and does not may re-obtain the first skill of the first virtual object.

According to the method provided by some embodiments, after a virtual object is defeated, a virtual resource of the virtual object is displayed, and after the virtual object revives, the virtual item dropped when the virtual object is defeated may be obtained again through interaction with the virtual resource. An error tolerance rate and playability in a game battle can be improved.

Some embodiments is described by only taking as an example that the first virtual object interacts with the virtual resource dropped from the first virtual object. In another embodiment, if the second virtual object of the second identity type interacts with the virtual resource dropped from the first virtual object, the second virtual object not only can obtain the first virtual item dropped from the first virtual object, but also can obtain the first skill of the first virtual object.

FIG. 13 is a schematic structural diagram of an apparatus for controlling a virtual object provided by some embodiments. Referring to FIG. 13, the apparatus includes:
a display module 1301 configured to display a first virtual object and a second virtual object, the first virtual object being of a first identity type and possessing a first skill of the first identity type, and the second virtual object being of a second identity type and possessing a second skill of the second identity type.

The display module 1301 is further configured to display a virtual resource dropped from the second virtual object when the first virtual object defeats the second virtual object.

The display module 1301 is further configured to display that the first virtual object obtains the second skill in response to an interaction operation of the first virtual object for the virtual resource dropped from the second virtual object.

According to the apparatus for controlling a virtual object provided by some embodiments, virtual objects of different identity types possess different skills. The first virtual object of the first identity type possesses the first skill corresponding to the first identity type, and the second virtual object of the second identity type possesses the second skill corresponding to the second identity type. If the first virtual object defeats the second virtual object, the virtual resource dropped from the second virtual object is displayed. When the first virtual object interacts with the virtual resource, it is displayed that the first virtual object obtains the second skill corresponding to the second identity type. A virtual object of an identity type may obtain, by defeating virtual objects of other identity types, skills that the virtual objects of the other identity types possess. A limitation that a virtual object of each identity type can only use a respective skill is broken, which helps improve the flexibility of controlling a virtual object, and enhances a player's game experience.

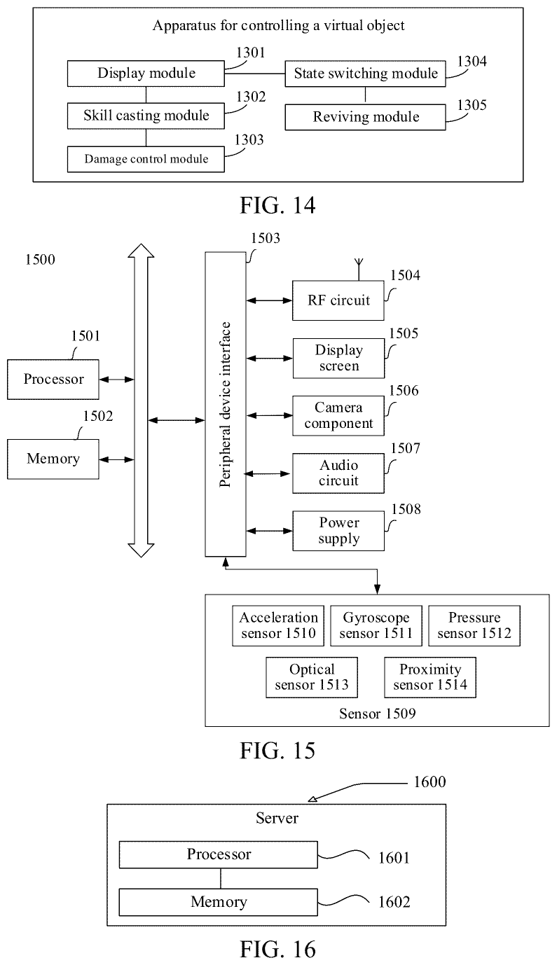

In one embodiment, referring to FIG. 14, the apparatus further includes:
a skill casting module 1302 configured to control the first virtual object to cast the second skill in response to a cast operation for the second skill.

In one embodiment, referring to FIG. 14, the first virtual object holds a first virtual prop of the first identity type; the second virtual object holds a second virtual prop of the second identity type; the second skill corresponds to a target action identifier which indicates a first action in an action module of the first identity type and further indicates a second action in an action module of the second identity type; and when casting the second skill, the second virtual object holds the second virtual prop to perform the second action.

The skill casting module 1302 is configured to:
control the first virtual object to cast the second skill and hold the first virtual prop to perform the first action in response to the cast operation for the second skill.

In one embodiment, referring to FIG. 14, the second skill further corresponds to a skill effect which is displayed when the second virtual object casts the second skill.

The skill casting module 1302 is configured to:
control the first virtual object to cast the second skill and display the skill effect in response to the cast operation for the second skill effect.

In one embodiment, referring to FIG. 14, damage caused by a virtual object of the first identity type is of a first damage type; damage caused by a virtual object of the second identity type is of a second damage type; and a virtual object hit after the second virtual object casts the second skill takes the damage of the second damage type. The apparatus further includes:
a damage control module 1303 configured to control a third virtual object to take the damage of the first damage type when the second skill cast by the first virtual object hits the third virtual object.

In one embodiment, referring to FIG. 14, the display module 1301 is further configured to:
display a skill bar of the first virtual object, the skill bar being configured to show a skill flag of a skill that the first virtual object possesses and including a skill flag of the first skill; and
add a skill flag of the second skill to the skill bar in response to the interaction operation of the first virtual object for the virtual resource dropped from the second virtual object.

In one embodiment, referring to FIG. 14, the skill bar includes a first skill bar configured to show a skill flag of a skill of the first identity type and a second skill bar configured to show a skill flag of a skill of another identity type other than the first identity type. The display module 1301 is configured to:
display the skill flag of the first skill in the first skill bar; and
add the skill flag of the second skill to the second skill bar in response to the interaction operation of the first virtual object for the virtual resource dropped from the second virtual object.

In one embodiment, referring to FIG. 14, the display module 1301 is further configured to:
display the second identity type at a location of the virtual resource dropped from the second virtual object.

In one embodiment, referring to FIG. 14, the second virtual object possesses a plurality of second skills of the second identity type. The display module 1301 is configured to:
display a skill selection list including the plurality of second skills in response to the interaction operation of the first virtual object for the virtual resource dropped from the second virtual object, and display that the first virtual object obtains a selected second skill in response to a select operation for any second skill; or
randomly determine a second skill among the plurality of second skills in response to the interaction operation of the first virtual object for the virtual resource dropped from the second virtual object, and display that the first virtual object obtains the randomly determined second skill; or
display that the first virtual object obtains the plurality of second skills in response to the interaction operation of the first virtual object for the virtual resource dropped from the second virtual object.

In one embodiment, referring to FIG. 14, the apparatus further includes:
a display module 1301 configured to display a virtual resource dropped from the first virtual object when the first virtual object is defeated;
a state switching module 1304 configured to switch the first virtual object to a dead state; and
a reviving module 1305 configured to control the first virtual object to revive when the first virtual object meets a reviving condition.

The display module 1301 is further configured to display that the first virtual object obtains a first virtual item in response to an interaction operation of the first virtual object for the virtual resource dropped from the first virtual object, the first virtual item being dropped when the first virtual object is defeated and being picked up by the first virtual object in a virtual scene.

In one embodiment, referring to FIG. 14, the display module 1301 is configured to:
display that the first virtual object obtains the second skill and a second virtual item in response to the interaction operation of the first virtual object for the virtual resource dropped from the second virtual object, the second virtual item being dropped when the second virtual object is defeated and being picked up by the second virtual object in the virtual scene.

In one embodiment, referring to FIG. 14, the display module 1301 is configured to:
display that the first virtual object obtains the second skill in response to the first virtual object touching the virtual resource dropped from the second virtual object; or
display that the first virtual object obtains the second skill in response to a trigger operation for an interactive option when a distance between the first virtual object and the virtual resource dropped from the second virtual object is less than a distance threshold.

The division of the above-mentioned functional modules of the apparatus for controlling a virtual object provided in the foregoing embodiments is merely used as an example. In practical application, the foregoing functions may be allocated to and completed by different functional modules. An internal structure of a computer device is divided into different functional modules to complete all or some of the functions described above. In addition, the apparatus for controlling a virtual object provided in the foregoing embodiments belongs to the same conception as the embodiments of the method for controlling a virtual object. For a implementation process, a reference is made to the method embodiments.

Some embodiments further provides a computer device which includes a processor and a memory. The memory has at least one computer program stored therein, and the at least one computer program is loaded and executed by the processor to implement operations performed in the method for controlling a virtual object of the foregoing embodiments.

In one embodiment, the computer device is provided as a terminal. FIG. 15 is a schematic structural diagram of a terminal 1500 provided by one example of embodiments of this application. The terminal 1500 includes a processor 1501 and a memory 1502.

The processor 1501 may include one or more processing cores, for example, a 4-core processor or an 8-core processor. The processor 1501 may be implemented in at least one hardware form of a digital signal processor (DSP), a field-programmable gate array (FPGA), and a programmable logic array (PLA). Alternatively, the processor 1501 may include a main processor and a coprocessor. The main processor is a processor configured to process data in an awake state, and is also referred to as a central processing unit (CPU). The coprocessor is a low power consumption processor configured to process the data in a standby state. In some embodiments, the processor 1501 may be integrated with a graphics processing unit (GPU). The GPU is configured to render and draw content that may be displayed on a display screen. In some embodiments, the processor 1501 may further include an artificial intelligence (AI) processor. The AI processor is configured to process computing operations related to machine learning.

The memory 1502 may include one or more computer-readable storage media, which may be non-transient. The memory 1502 may further include a high-speed random access memory and a non-volatile memory such as one or more magnetic disk storage devices and a flash storage device. In some embodiments, a non-transitory computer-readable storage medium in the memory 1502 is configured to store at least one computer program, and the at least one instruction is configured to be executed by the processor 1501 to implement the method for controlling a virtual object provided in the method embodiments of this application.

In some embodiments, the terminal 1500 may alternatively include a peripheral interface 1503 and at least one peripheral device. The processor 1501, the memory 1502, and the peripheral device interface 1503 may be connected through a bus or a signal cable. Each peripheral device may be connected to the peripheral device interface 1503 through a bus, a signal cable, or a circuit board. In one embodiment, the peripheral device includes at least one of a radio frequency (RF) circuit 1504, a display screen 1505, a camera component 1506, an audio circuit 1507, and a power supply 1508.

The peripheral interface 1503 may be configured to connect the at least one peripheral related to input/output (I/O) to the processor 1501 and the memory 1502. In some embodiments, the processor 1501, the memory 1502, and the peripheral device interface 1503 are integrated on a same chip or circuit board. In some other embodiments, any one or two of the processor 1501, the memory 1502, and the peripheral device interface 1503 may be implemented on a single chip or circuit board. This is not limited in some embodiments.

The RF circuit 1504 is configured to receive and transmit an RF signal, also referred to as an electromagnetic signal. The RF circuit 1504 communicates with a communication network and other communication devices through the electromagnetic signal. The RF circuit 1504 converts an electric signal into an electromagnetic signal for transmission, or converts a received electromagnetic signal into an electric signal. In one embodiment, the RF circuit 1504 includes an antenna and feeder system, an RF transceiver, one or more amplifiers, a tuner, an oscillator, a digital signal processor, a codec chip set, a subscriber identity module card, and the like.

The display 1505 is configured to display a user interface (UI). The UI may include a graph, a text, an icon, a video, and any combination thereof. When the display 1505 is a touch display, the display 1505 is further capable of acquiring a touch signal on or above a surface of the display 1505. The touch signal may be inputted as a control signal to the processor 1501 for processing. In this case, the display 1505 may be further configured to provide a virtual button and/or a virtual keyboard, which is also referred to as a soft button and/or a soft keyboard.

The camera component 1506 is configured to acquire an image or a video. In one embodiment, the camera component 1506 includes a front-facing camera and a rear-facing camera. The front camera is disposed on a front panel of the terminal 1500, and the rear-facing camera is disposed on a rear face of the terminal 1500.

The audio circuit 1507 may include a microphone and a speaker. The microphone is configured to acquire sound waves of a user and an environment, and convert the sound waves into an electrical signal to input to the processor 1501 for processing, or input to the radio frequency circuit 1504 for implementing voice communication. The speaker is configured to convert electric signals from the processor 1501 or the RF circuit 1504 into sound waves.

The power supply 1508 is configured to supply power to the components in the terminal 1500. The power supply 1508 may be an alternating current, a direct current, a disposable battery, or a rechargeable battery. When the power supply 1508 includes the rechargeable battery, the rechargeable battery may support wired charging or wireless charging. The rechargeable battery may be further configured to support a fast charge technology.

In some embodiments, the terminal 1500 further includes one or more sensors 1509. The one or more sensors 1509 include but are not limited to an acceleration sensor 1510, a gyroscope sensor 1511, a pressure sensor 1512, an optical sensor 1513, and a proximity sensor 1514.

A person skilled in the art may understand that the structure shown in FIG. 15 constitutes no limitation on the terminal 1500, and the terminal may include more or fewer components than those shown in the figure, or some components may be combined, or a different component deployment may be used.

In one embodiment, the computer device is provided as a server. FIG. 16 is a schematic diagram of a structure of a server according to some embodiments. The server 1600 may vary greatly due to different configurations or performance, and may include one or more central processing units (CPU) 1601 and one or more memories 1602. The memory 1602 has at least one computer program stored therein. The at least one computer program is loaded and executed by the processor 1601 to implement the methods provided in the foregoing method embodiments. Certainly, the server may alternatively have components such as a wired or wireless network interface, a keyboard, and an input/output interface, for input and output. The server may further include other components for implementing the functions of the device, which will not be described redundantly here.

Some embodiments further provides a computer-readable storage medium having at least one computer program stored therein. The at least one computer program is loaded and executed by a processor to implement operations performed in the method for controlling a virtual object of the foregoing embodiments.

Some embodiments further provides a computer program product, including a computer program which is loaded and executed by a processor to implement operations performed in the method for controlling a virtual object of the foregoing embodiments.

A person of ordinary skill in the art may understand that all or some of the operations of the foregoing embodiments may be implemented by hardware, or may be implemented by a program instructing relevant hardware. The program may be stored in a computer-readable storage medium. The aforementioned storage medium may be a read-only memory, a magnetic disk, an optical disc, or the like.

The above descriptions are merely alternative ones of some embodiments, and are not intended to limit some embodiments. Any modification, equivalent replacement, improvement, or the like made within the spirit and principle of some embodiments falls within the protection scope of this application.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for controlling a virtual object, performed by a computer device, the method comprising:
displaying, in a virtual scene, a first virtual object of a first identity type possessing a first skill of the first identity type;
displaying, in a virtual scene, a second virtual object of a second identity type possessing a second skill of the second identity type;
displaying a virtual resource dropped from the second virtual object in a case that the first virtual object defeats the second virtual object; and
displaying that the first virtual object obtains the second skill based on an interaction operation of the first virtual object for the virtual resource dropped from the second virtual object.

2. The method according to claim 1, further comprising:
controlling the first virtual object to cast the second skill based on a cast operation for the second skill.

3. The method according to claim 2, wherein
the first virtual object holds a first virtual prop of the first identity type,
the second virtual object holds a second virtual prop of the second identity type,
the second skill corresponds to a target action identifier which indicates both a first action in an action module of the first identity type and a second action in an action module of the second identity type;
in a case that the second virtual object casting the second skill, the second virtual object holds the second virtual prop to perform the second action; and
wherein the controlling the first virtual object to cast the second skill comprises:
controlling the first virtual object to hold the first virtual prop to perform the first action based on the cast operation for the second skill.

4. The method according to claim 2, wherein the second skill corresponds to a skill effect which is displayed in a case that the second virtual object casts the second skill; and
wherein the controlling the first virtual object to cast the second skill further comprises:
displaying the skill effect based on the cast operation for the second skill.

5. The method according to claim 2,
wherein damage caused by a virtual object of the first identity type is of a first damage type; damage caused by a virtual object of the second identity type is of a second damage type;
a virtual object hit by the second skill cast by the second virtual object takes damage of the second damage type; and
the method further comprises:
controlling a third virtual object to take the damage of the first damage type in a case that the second skill cast by the first virtual object hits the third virtual object.

6. The method according to claim 1, further comprising:
displaying a skill bar of the first virtual object configured to show a skill flag of a skill possessed by the first virtual object and include a skill flag of the first skill, and
wherein the displaying that the first virtual object obtains the second skill comprising:
adding a skill flag of the second skill to the skill bar based on the interaction operation of the first virtual object for the virtual resource dropped from the second virtual object.

7. The method according to claim 6, wherein the skill bar comprises:
a first skill bar configured to show a skill flag of a skill of the first identity type;
a second skill bar configured to show a skill flag of a skill of at least one identity type other than the first identity type;
wherein the displaying a skill bar of the first virtual object comprises:
displaying the skill flag of the first skill in the first skill bar; and
wherein the adding a skill flag of the second skill to the skill bar comprises:
adding the skill flag of the second skill to the second skill bar based on the interaction operation of the first virtual object for the virtual resource dropped from the second virtual object.

8. The method according to claim 1, further comprising:
displaying the second identity type at a location of the virtual resource dropped from the second virtual object.

9. The method according to claim 1,
wherein the second virtual object possesses a plurality of second skills of the second identity type;
wherein the displaying that the first virtual object obtains the second skill comprises at least one of:
displaying a skill selection list comprising the plurality of second skills based on the interaction operation of the first virtual object for the virtual resource, and displaying that the first virtual object obtains a selected second skill based on a select operation for one of the plurality of second skills;
randomly determining a second skill among the plurality of second skills based on the interaction operation of the first virtual object for the virtual resource dropped from the second virtual object, and displaying that the first virtual object obtains the randomly determined second skill; or
displaying that the first virtual object obtains the plurality of second skills based on the interaction operation of the first virtual object for the virtual resource.

10. The method according to claim 1, further comprising:
displaying a virtual resource dropped from the first virtual object and switching the first virtual object to a dead state in a case that the first virtual object is defeated;
controlling the first virtual object to revive in a case that the first virtual object meets a reviving condition; and
displaying that the first virtual object obtains a first virtual item based on the interaction operation of the first virtual object for the virtual resource,
wherein the first virtual item was dropped in a case that the first virtual object is defeated.

11. An apparatus for controlling a virtual object, comprising:
at least one memory configured to store program code; and
at least one processor configured to read the program code and operate as instructed by the program code, the program code comprising:
first display code configured to cause at least one of the at least one processor to display, in a virtual scene, a first virtual object of a first identity type possessing a first skill of the first identity type;
second display code configured to cause at least one of the at least one processor to display, in a virtual scene, a second virtual object of a second identity type possessing a second skill of the second identity type;
resource code configured to cause at least one of the at least one processor to display a virtual resource dropped from the second virtual object in a case that the first virtual object defeats the second virtual object; and
skill code configured to cause at least one of the at least one processor to display that the first virtual object obtains the second skill based on an interaction operation of the first virtual object for the virtual resource dropped from the second virtual object.

12. The apparatus according to claim 11, wherein the program code further comprises:
control code configured to cause at least one of the at least one processor to control the first virtual object to cast the second skill based on a cast operation for the second skill.

13. The apparatus according to claim 12, wherein
the first virtual object holds a first virtual prop of the first identity type,
the second virtual object holds a second virtual prop of the second identity type,
the second skill corresponds to a target action identifier which indicates both a first action in an action module of the first identity type and a second action in an action module of the second identity type;
in a case that the second virtual object casting the second skill, the second virtual object holds the second virtual prop to perform the second action; and
wherein the control code is further configured to cause at least one of the at least one processor to:
control the first virtual object to hold the first virtual prop to perform the first action based on the cast operation for the second skill.

14. The apparatus according to claim 12, wherein the second skill corresponds to a skill effect which is displayed in a case that the second virtual object casts the second skill; and
wherein the control code is further configured to cause at least one of the at least one processor to:
display the skill effect based on the cast operation for the second skill.

15. The apparatus according to claim 12,
wherein damage caused by a virtual object of the first identity type is of a first damage type; damage caused by a virtual object of the second identity type is of a second damage type;
a virtual object hit by the second skill cast by the second virtual object takes damage of the second damage type; and
wherein the control code is further configured to cause at least one of the at least one processor to:
control a third virtual object to take the damage of the first damage type in a case that the second skill cast by the first virtual object hits the third virtual object.

16. The apparatus according to claim 11, wherein the program code further comprises:
bar code configured to cause at least one of the at least one processor to display a skill bar of the first virtual object configured to show a skill flag of a skill possessed by the first virtual object and include a skill flag of the first skill, and
wherein the skill code is further configured to cause at least one of the at least one processor to:
add a skill flag of the second skill to the skill bar based on the interaction operation of the first virtual object for the virtual resource dropped from the second virtual object.

17. The apparatus according to claim 16, wherein the skill bar comprises:
a first skill bar configured to show a skill flag of a skill of the first identity type;
a second skill bar configured to show a skill flag of a skill of at least one identity type other than the first identity type;
wherein the bar code is further configured to cause at least one of the at least one processor to:
display the skill flag of the first skill in the first skill bar; and
wherein the skill code is further configured to cause at least one of the at least one processor to:
add the skill flag of the second skill to the second skill bar based on the interaction operation of the first virtual object for the virtual resource dropped from the second virtual object.

18. The apparatus according to claim 11, wherein the program code further comprises:
identity code configured to cause at least one of the at least one processor to display the second identity type at a location of the virtual resource dropped from the second virtual object.

19. The apparatus according to claim 11,
wherein the second virtual object possesses a plurality of second skills of the second identity type;
wherein the skill code is further configured to cause at least one of the at least one processor to perform at least one of:
display a skill selection list comprising the plurality of second skills based on the interaction operation of the first virtual object for the virtual resource, and display that the first virtual object obtains a selected second skill based on a select operation for one of the plurality of second skills;
randomly determine a second skill among the plurality of second skills based on the interaction operation of the first virtual object for the virtual resource dropped from the second virtual object, and display that the first virtual object obtains the randomly determined second skill; or
display that the first virtual object obtains the plurality of second skills based on the interaction operation of the first virtual object for the virtual resource.

20. A non-transitory computer-readable storage medium, storing computer code which, when executed by at least one processor, causes the at least one processor to at least:
display, in a virtual scene, a first virtual object of a first identity type possessing a first skill of the first identity type;
display, in a virtual scene, a second virtual object of a second identity type possessing a second skill of the second identity type;
display a virtual resource dropped from the second virtual object in a case that the first virtual object defeats the second virtual object; and
display that the first virtual object obtains the second skill based on an interaction operation of the first virtual object for the virtual resource dropped from the second virtual object.
